(19) United States
(12) Patent Application Publication
(10) Pub. No.: US 2015/0183498 A1
(43) Pub. Date: Jul. 2, 2015

(54) Personal Submersible Drone for Aquatic Exploration

(71) Applicant: Patrick Wardle, Kula, HI (US)

(72) Inventor: Patrick Wardle, Kula, HI (US)

(21) Appl. No.: 14/143,713

(22) Filed: Dec. 30, 2013

(51) Int. Cl. B63G 8/38; B63B 35/85; G08B 21/02; B63G 8/08

(52) U.S. Cl. CPC B63G 8/38; B63G 8/08; B63B 35/85; G08B 21/02

(57) ABSTRACT

The invention is directed toward an autonomous submersible aquatic drone, a system utilizing an autonomous submersible aquatic drone and a control unit, a control unit for controlling an autonomous submersible aquatic drone, and a method for using the same. The autonomous submersible aquatic drone comprises a shaped housing, a propulsion system, one or more electromotors, a camera, a sonar unit, a wireless transponder, a battery, a microcontroller unit, and a control hardware unit. The control hardware unit is configured with artificial intelligence logic. The submersible drone surveys a predetermined area around a person engaged in a water sport for the presence of an underwater threat. When the aquatic drone detects the presence of an underwater threat the submersible drone sends a warning signal to a control unit worn by the person. The aquatic drone may also have a threat response unit to deter an attack on the person.

### FIELD OF THE INVENTION

The present invention relates generally to a personal aquatic submersible drone and more particularly to a device and system for an autonomous aquatic submersible drone which circulates around a person in an aquatic environment to provide an early warning regarding a personal threat and possible threat deterrence.

### BACKGROUND OF THE INVENTION

There are many recreational activities or sports that occur in the ocean that require the participant to be partially or fully submerged in the water. Such activities include snorkeling, scuba diving, surfing, or boating. Many of these activities can occur in dangerous marine environments. There may be unseen underwater obstacles such as rocks and boulders. In addition, reports of shark attacks on humans is rising. Surfers are frequently unsure of whether there are sharks present in the vicinity of the surfers. What is needed is a device to be utilized in the vicinity of a person while engaging in a water activity that presents the person with an alarm notification when an underwater threat is detected that also has the ability to possibly deter any attack and prevent any harm to the person.

### SUMMARY OF THE INVENTION

The invention is directed toward a personal submersible aquatic drone to be used to explore and detail aquatic environments. The personal submersible aquatic drone comprises a shaped housing, a propulsion system, one or more electromotors, a camera, a sonar unit, a wireless transponder, a battery, a microcontroller unit, and a control hardware unit. The control hardware unit is configured with artificial intelligence logic to process information received from the camera, the sonar unit, and the wireless transponder. The submersible aquatic drone may further comprise a plurality of stabilizing fins, a GPS unit, and a memory storage component. The artificial intelligence logic processes information received from the GPS unit. The submersible aquatic drone may further comprise a USB port. The submersible aquatic drone may further comprise a touch screen digital display. In this embodiment the touch screen digital display displays information related to the operation of the submersible aquatic drone and permits a user to enter instruction information to the submersible aquatic drone. The submersible aquatic drone may further comprise a threat response unit. The threat response unit presents a stimulus to an underwater threat to prevent an attack on a person engaged in an aquatic activity.

In another embodiment of the invention the submersible aquatic drone comprises a shaped housing, a propulsion system, one or more electromotors, a camera, a sonar unit, a wireless transponder, a battery, a microcontroller unit, a control hardware unit, and a threat response unit. The control hardware unit is configured with artificial intelligence logic to process information received from the camera, the sonar unit, and the wireless transponder. The threat response unit presents a stimulus to an underwater threat to prevent an attack on a person engaged in an aquatic activity.

In another embodiment of the invention the submersible aquatic drone comprises a shaped housing, a propulsion system, one or more electromotors, a camera, a sonar unit, a wireless transponder, a battery, a microcontroller unit, a control hardware unit, and a touch screen digital display. The control hardware unit is configured with artificial intelligence logic to process information received from the camera, the sonar unit, and the wireless transponder. The touch screen digital display displays information related to the operation of the submersible aquatic drone and permits a user to enter instruction information to the submersible aquatic drone.

The invention is also directed toward a system for exploring searching and responding to an underwater threat. The system comprises a submersible aquatic drone and one or more control units. The control units comprise a microcontroller unit, a memory storage component, and a wireless transponder. In this system the submersible aquatic drone operates within a predetermined area and the submersible aquatic drone transmits a warning signal to the control unit when the submersible aquatic drone detects the presence of an underwater threat. In this system the control unit may further comprise a flexible strap housing. Alternatively, in this system, the control unit may further comprise a plurality of warning lights. The plurality of warning lights activate and enlighten when the control unit receives a warning signal from the aquatic drone. In this embodiment of the system the control unit may further comprise a warning sound emitter. The warning sound emitter emits an audible alarm when the control unit receives a warning signal from the aquatic drone. In this embodiment of the system the control unit may further comprise an alert hardware unit. The alert hardware unit vibrates or emits an electrical impulse when the control unit receives a warning signal from the aquatic drone. In this embodiment of the system the control unit may further comprise a plurality of control buttons. Each of the control buttons provides a unique instruction to the aquatic drone. In this embodiment of the system the control unit may further comprise a touch screen visual display. The touch screen visual display displays information related to the operation of the submersible aquatic drone and permits a user to enter instruction information to the submersible aquatic drone. In this embodiment of the system the control unit may further comprise a battery and a USB port. In this embodiment of the system the control unit may further comprise a flexible strap housing. In this embodiment of the system the submersible aquatic drone comprises a shaped housing, a propulsion system, one or more electromotors, a camera, a sonar unit, a wireless transponder, a battery, a microcontroller unit, a control hardware unit, a plurality of stabilizing fins, a GPS unit, a memory storage component, a USB port, a touch screen digital display, and a threat response unit. The control hardware unit is configured with artificial intelligence logic to process information received from the camera, the sonar unit, the GPS unit, and the wireless transponder. The touch screen digital display displays information related to the operation of the submersible aquatic drone and permits a user to enter instruction information to the submersible aquatic drone. The threat response unit presents a stimulus to an underwater threat to prevent an attack on a person engaged in an aquatic activity.

In another embodiment of the invention the system comprises a submersible aquatic drone and one or more control units where the control units comprise a microcontroller unit, a memory storage component, a wireless transponder, and an alert hardware unit. In this system the submersible aquatic drone operates within a predetermined area and the submersible aquatic drone transmits a warning signal to the control unit when the submersible aquatic drone detects the presence of an underwater threat. The alert hardware unit vibrates or emits an electrical impulse when the control unit receives a warning signal from the aquatic drone.

In another embodiment of the invention the system comprises a submersible aquatic drone and one or more control units where the control units comprise a microcontroller unit, a memory storage component, a wireless transponder, and a plurality of control buttons. In this system the submersible aquatic drone operates within a predetermined area and the submersible aquatic drone transmits a warning signal to the control unit when the submersible aquatic drone detects the presence of an underwater threat. Each of the control buttons provides a unique instruction to the aquatic drone.

In another embodiment of the invention the system comprises a submersible aquatic drone and one or more control units where the control units comprise a microcontroller unit, a memory storage component, a wireless transponder, and a touch screen visual display. In this system the submersible aquatic drone operates within a predetermined area and the submersible aquatic drone transmits a warning signal to the control unit when the submersible aquatic drone detects the presence of an underwater threat. The touch screen visual display displays information related to the operation of the submersible aquatic drone and permits a user to enter instruction information to the submersible aquatic drone.

The invention is also directed toward a control unit for controlling and communicating with an autonomous submersible aquatic drone. The control unit comprises a microcontroller unit, a memory storage component, a wireless transponder, and a battery. The control unit transmits and receives a substantially continuous signal with an autonomous submersible aquatic drone. The autonomous submersible aquatic drone operates within a predetermined area. The control unit may further comprise a warning system. The warning system alerts a user of the control unit when the autonomous submersible aquatic drone detects the presence of an underwater threat. The control unit may further comprise a flexible strap housing.

The invention is also directed toward a method for surveying an aquatic environment. The method comprises placing an autonomous submersible aquatic drone in the vicinity of a person engaged in a water sport and transmitting a substantially continuous location signal from a control unit to the autonomous submersible aquatic drone. The autonomous submersible aquatic drone operates within a predetermined area. The method may further comprise the autonomous submersible aquatic drone following the person in the water, the autonomous submersible aquatic drone pointing a camera at the person, recording video of the person with the camera of the autonomous submersible aquatic drone, and storing the video on a memory unit located in the autonomous submersible aquatic drone. This embodiment of the method may further comprise the autonomous submersible aquatic drone surveying the vicinity surrounding the person for the presence of an underwater threat, transmitting a warning signal from the autonomous submersible aquatic drone to the control unit when the autonomous submersible aquatic drone detects an underwater threat, and activating an alarm in the control unit when the control unit receives the warning signal.

In this embodiment of the invention, the method may further comprise responding to an underwater threat with a stimulus from the autonomous submersible aquatic drone to prevent an attack on the person wearing the control unit. This may also further comprise transmitting a warning signal from the autonomous submersible aquatic drone to a plurality of control units when the autonomous submersible aquatic drone detects an underwater threat and activating an alarm in the control unit when the plurality of control units receives the warning signal.

In any embodiment of the method, the predetermined area may be established within a predetermined circumference from the control unit and the person engaged in a water sport wears the control unit.

Alternatively, in any embodiment of the method, the predetermined area may be established via a GPS signal received by the submersible aquatic drone and the control unit is utilized by a person located outside of the water

### BRIEF DESCRIPTION OF THE DRAWINGS

FIG. 1 is a view of the aquatic drone in use.

FIG. 2 is an external side view of the aquatic drone.

FIG. 3 is view of the internal and external functional components of the aquatic drone.

FIG. 4 is a view of the control device.

FIG. 5 is a view of the internal functional components of the control device.

### DETAILED DESCRIPTION OF THE DRAWINGS

Although the present invention will be described with reference to the exemplary embodiments shown in the drawings, it should be understood that the present invention can be embodied in many alternate forms or embodiments.

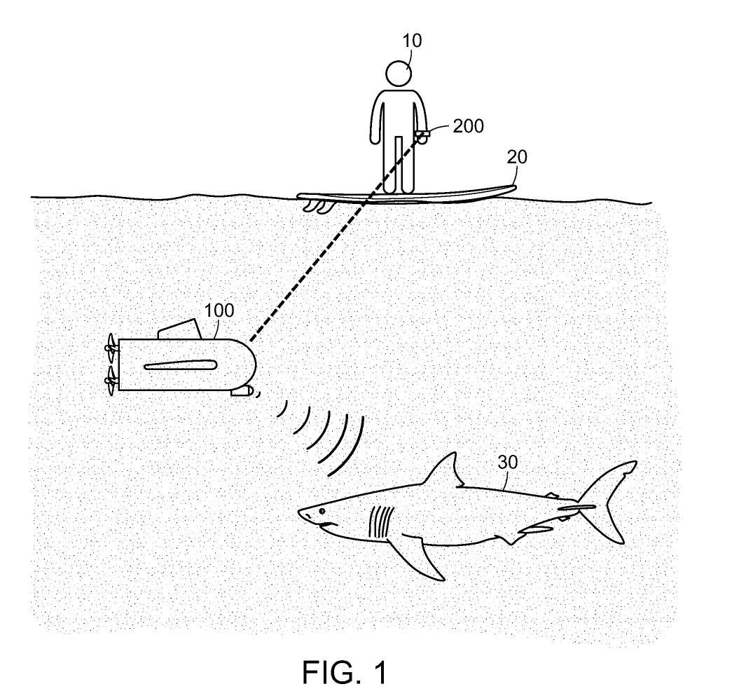

Referring to FIG. 1, the use of the aquatic drone is displayed. In this embodiment, a person 10 is engaged in an aquatic recreational activity involving a surfboard 20. The person 10 utilizes an aquatic drone 100 which circles around under the water in the vicinity of the person 10. When the aquatic drone 100 detects an underwater threat, such as a shark 30, the aquatic drone sends a wireless signal to a control unit 200 which is worn by the person 10. In this manner the person 10 is notified of the existence of the underwater threat and can take the appropriate action.

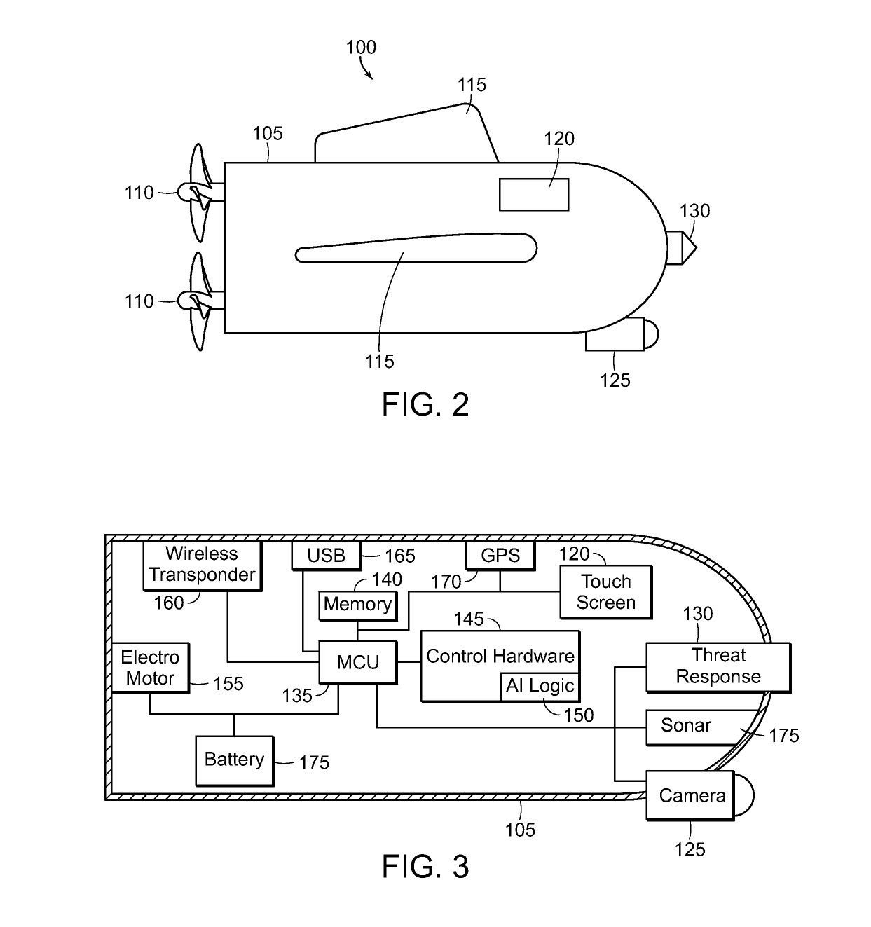

Referring to FIG. 2, the exterior of the aquatic drone 100 is displayed. The aquatic drone 100 is designed to be buoyant in the water. The aquatic drone 100 may operate along the surface of the water when used in the ocean or may submerge and operate underwater. The aquatic drone is comprised of a shaped housing 105. The shaped housing 105 can be of any aerodynamic shape which permits the aquatic drone 100 to operate in water with minimal drag. The shaped housing 105 may be made of any material. In the preferred embodiment, the shaped housing 105 is composed of a durable polymer foam which gives the aquatic drone 100 buoyancy and reduces the weight of the aquatic drone 100. The aquatic drone contains a propulsion system 110 which permits the aquatic drone 100 to move freely about in the water. In preferred embodiment, the propulsion system 110 permits the aquatic drone 100 to turn to the right or left, change pitch or yaw, strafe, spin, and move in forward and reverse. The propulsion system 110 may take the form of any common components utilized for the propulsion of submersibles. The structures of the propulsion system 110 may take the form of a plurality of propellers or fans. The aquatic drone 100 contains a plurality of stabilizing fins 115. The stabilizing fins 115 permit the drone to remain in the proper position and orientation when operating in the water. The stabilizing fins 115 may be separate from the shaped housing 105 or may be extensions of the shaped housing 105. The aquatic drone 100 also contains a touch screen digital display 120 as a user interface. The touch screen digital display 120 presents a user with any relevant information pertaining to the operation of the aquatic drone 100. The touch screen digital display 120 also allows a user to enter commands and control the operation of the aquatic drone 100. The aquatic drone utilizes an underwater camera 125 to view the underwater environment to detect an underwater threat 30. The underwater camera 125 may be located in any position on the shaped housing 105 of the aquatic drone 100. The underwater camera 125 may be located outside of the shaped housing 105 or inside the shaped housing 105. Preferably, the underwater camera 125 is positioned on the bottom of the shaped housing 105 and receives a panoramic (360 degree) view of the underwater environment. Optionally, there may be multiple underwater cameras 125 positioned around the shaped housing 105 to ensure that the entire underwater environment is viewed by the aquatic drone 100, thus increasing the effectiveness of the aquatic drone 100.

Optionally, the aquatic drone 100 may have a threat response unit 130. The threat response unit 130 is designed to respond to an underwater threat 30 in order to cause the underwater threat 30 to leave the vicinity of the aquatic drone 100, and therefore the person 10. It is the ultimate goal of the threat response unit 130 to prevent and deter the underwater threat 30 from attacking and harming the person 10. The threat response unit 130 may be any type of device that is designed to cause the underwater threat 30 to become aware of the aquatic drone 100 or to cause discomfort to the underwater threat 30. The threat response unit 130 may display flashing lights or emit sounds in an effort to confuse and disorient the underwater threat 30. The threat response unit 130 may emit an electrical shock, or a series of electrical shocks, to the underwater threat 30. The threat response unit 130 may also launch a projectile, or a series of projectiles, at the underwater threat 30.

Referring to FIG. 3, the internal and external functional components of the aquatic drone 100 are displayed. In the preferred embodiment, the functional components are located within the shaped housing 105. However, any single functional component, or all functional components, may be located outside of the shaped housing 105. Regardless of the location of the functional components of the aquatic drone 100, the functional components are designed to be waterproof and operate in the aquatic environment without malfunctioning. The central functional component is a microcontroller unit 135. The microcontroller unit 135 is connected to a drone memory unit 140, a control hardware unit 145, a drone wireless transponder 160, a USB port 165, a GPS unit 170, a sonar unit 175, the touch screen digital display 120, the threat response unit 130, the underwater camera 125, an electromotor 155, and a battery 175.

The control hardware unit 145 houses and executes an artificial intelligence logic 150. The artificial intelligence logic 150 controls the behavior of the aquatic drone 100 when in the water. The artificial intelligence logic 150 is programmed to recognize potential threats, analyze the imminence of any potential threat, and determine the appropriate response. The drone memory unit 140 is a standard type of computer memory device which stores information obtained by the aquatic drone 100 when in operation. The information stored in the drone memory unit 140 can be transmitted to a separate computing device or accessed at a later point in time when the aquatic drone 100 is no longer in use. The drone memory unit 140 may store any type of information, including but not limited to, location information, threat detection history, movement history, images, and video.

The sonar unit 175 is used separately from or in conjunction with the underwater camera 125. When the aquatic drone 100 is in utilized in an underwater environment that is cloudy, murky, or contains a multitude of particulate material, the underwater camera 125 may not clearly detect an underwater threat 30. In this instance the aquatic drone 100 utilizes the sonar unit 175 to detect potential underwater threats 30.

The drone wireless transponder 160 sends and receives information to and from the control unit 200. In the preferred embodiment, the drone wireless transponder 160 sends a steady stream of information to and from the control unit 200. The constant communication between the aquatic drone 100 and the control unit 200 via the drone wireless transponder 160 permits the artificial intelligence logic to determine the location of the user 10 in reference to the aquatic drone 100. In this manner the aquatic drone 100 is kept within the vicinity of the user 10. Thus as the user 10 moves and changes location in the aquatic environment, the aquatic drone 100 maintains an approximate distance to the user 10 and stays within the vicinity of the user 10.

The GPS unit 170 tracks and guides the location of the aquatic drone 170. The electromotor 155 provides power to the propulsion system 110. The aquatic drone may contain a plurality of electromotors 155. Optionally, the electromotor 155 may be an integral component of the propulsion system 110. The USB port 165 may be utilized for a person 10 to interface with the aquatic drone 100. A user 10 may recharge the battery 175 through the USB port 165 and download information stored on the drone memory unit 140 to a computing device through the USB port 165.

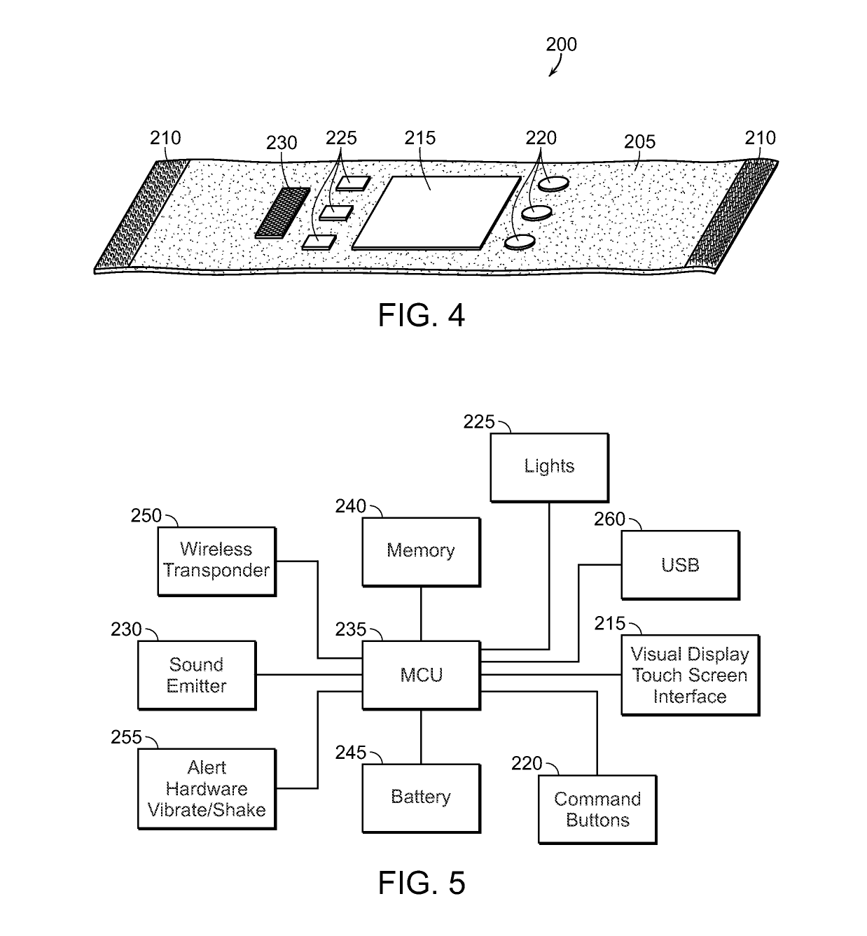

Referring to FIG. 4, the control unit 200 is displayed. The control unit 200 is primarily maintained in a flexible strap 205. The flexible strap 205 may be comprised of any type of standard material. Preferably the flexible strap 205 is composed of a woven synthetic material. The flexible strap 205 contains a means to removably secure the flexible strap 205 to itself. In the displayed embodiment, the flexible strap contains end sections of hook and loop tape 210 to secure the flexible strap 105 to itself. In this manner the flexible strap 105 may be worn as an armband by the user 10 or may be connected to a leash which connects the user 10 to a surfboard 20. In an alternative embodiment, the control unit 200 may be securely attached to an existing flexible strap 105 which is part of a leash assembly utilized for securing a user 10 to a surfboard 20 or other water sporting device.

The control unit 200 contains a touch screen visual display 215. The touch screen visual display 215 may be a firm and nonflexible screen or alternatively may be a flexible, bendable screen. The flexible screen permits the touch screen visual display 215 to integrate easily and comfortably into the flexible strap 105. The touch screen visual display 215 presents the user 10 with information regarding the aquatic drone 100. The information presented may include any type of relevant information, including but not limited to, battery life, distance from the user 10, visual images from the underwater camera 125, or the presence of an underwater threat 30. The user may also use the touch screen visual display 215 to enter commands to the aquatic drone 100. Separately from entering commands into the touch screen visual display 215, the user may also utilize a plurality of control buttons 220. In one embodiment, the control unit 200 may utilize solely the touch screen visual display 215 to permit the user to control the aquatic drone and may not contain command buttons 220. In another embodiment the control unit 200 contains solely the command buttons 220 without the touch screen visual display 215. The command buttons 220 provide the user 10 with a quick and short hand method of giving the aquatic drone 100 a specific command. The command buttons 220 may give the aquatic drone 100 any type of command that may be used to control the aquatic drone 100. Types of commands which may be associated with the command buttons may include, but not be limited to, instructing the aquatic drone 100 to prowl in the vicinity of the user 10, instructing the aquatic drone 100 to stop, instructing the aquatic drone 100 to surface, instructing the aquatic drone 100 the dive, and instructing the aquatic drone 100 to return to the user 10. The control unit 200 may also contain a plurality of warning lights 225. The control unit 200 may also contain a sound emitter 230. The plurality of warning lights 225 may light up when the aquatic drone 100 senses an underwater threat 30. Additionally, the sound emitter 230 may emit a warning sound when the aquatic drone 100 senses an underwater threat 30.

Referring to FIG. 5, the functional internal components of the control unit 200 are displayed. The functional components of the control unit 200 are contained in a manner that the functional components are water proof. The control unit 200 contains a microcontroller unit 235. The microcontroller unit 235 is connected to a memory unit 240, the sound emitter 230, the warning lights 225, the touch screen visual display 215, the command buttons 220, a control unit wireless transponder 250, a battery 245, a control unit alert hardware 255, and a USB port 260. The memory unit 240 is a standard type of computer memory device which stores information obtained by the aquatic drone 100 when in operation. The control unit alert hardware 255 is a physical device which presents a physical stimulus to the person 10 when an underwater threat 30 is detected. The control unit alert hardware 255 presents any type of physical stimulus to the person 10 in order to notify the person 10 of an underwater threat 30. For instance, the control unit alert hardware 255 may vibrate when an underwater threat 30 is detected. Alternatively, the control unit alert hardware 255 may present a small electroshock to the person 10 when an underwater threat 30 is detected. The USB port 260 may be utilized for a person 10 to interface with the control unit 200. A user 10 may recharge the battery 245 through the USB port 260 and download information stored on the memory unit 240 to a computing device through the USB port 260.

In the preferred use of the invention, the person 10 places the aquatic drone 100 in the water when the person is using a surfboard 20. The person 10 wears the control unit 200 around the person's 10 wrist. The drone wireless transponder 160 communicates substantially continuously with the control unit wireless transponder 250 to enable the aquatic drone 100 to remain in the vicinity of the person 10. The aquatic drone 100 roams within a predetermined circumference from the person 10. The predetermined circumference establishes the preferred maximum distance from the person 10 that the aquatic drone 100 operates. The aquatic drone 100 roams and prowls within the predetermined circumference as determined by the artificial intelligence logic 150 residing on the control hardware unit 145. When the aquatic drone 100 reaches the outer distance from the person 10 that is established by the predetermined circumference, the aquatic drone 100 proceeds no further away from the person 10. The aquatic drone 100 either returns closer to the person 10 or proceeds around the edge of the predetermined circumference. While roaming within the predetermined circumference, the aquatic drone actively searches for the presence of an underwater threat 30. The aquatic drone 100 utilizes the underwater camera 125 and sonar unit 175 to search for the presence of an underwater threat 30.

When the aquatic drone 100 recognizes the presence of an underwater threat 30, the aquatic drone sends a warning signal from the aquatic drone 100 to the control unit 200 by transmitting the warning signal from the drone wireless transponder 160 to the control unit wireless transponder 250. When the control unit 200 receives the warning signal, the control unit 200 notifies the person 10 of the presence of the underwater threat 30 by activating the warning lights 225, the sound emitter 230, and the alert hardware 255. When determining that an underwater threat 30 is present, the aquatic drone 100 may take an appropriate response to deter an attack on the person 10 by utilizing the threat response unit 130 to engage the underwater threat 30.

As the person 10 utilizes the surfboard 20, the person 10 moves from deeper water to shallower water. The aquatic drone 100 preferably stays within the predetermined circumference and moves with the person 10 into the shallower water. As the person 10 returns to deeper water, the aquatic drone 10 preferably moves with the person 10 into the deeper water. The aquatic drone 100 may also be instructed to remain in the deeper water as the person 10 surfs on a wave as an underwater threat 30 would be more likely to exist in the deeper water. Preferably, the aquatic drone 100 tracks the location where the person 10 first launches the aquatic drone 100 into the water via the GPS unit 170. If the aquatic drone 100 moves outside of the predetermined circumference, or for any reason loses the communication signal with the control unit 200 then the aquatic drone 100 will utilize the GPS unit 170 to return to the location where the person 10 first launched the aquatic drone 100. Likewise, if the battery 175 of the aquatic drone 100 reaches a critically low level then the aquatic drone 100 will surface and move to the location where the person 10 first launched the aquatic drone 100.

The operation of the aquatic drone 100 may occur in multiple embodiments. The aquatic drone 100 may be utilized in any manner which may be desired or controlled by the person 10 or may be completely autonomous in its operation. The aquatic drone 100 stays in substantially continuous communication with the control unit 200. If the aquatic drone 100 experiences interference with the signal between the aquatic drone 100 and the control unit 200 when the aquatic drone 100 is underwater then the aquatic drone 100 will rise to the surface of the water and ping the control unit 200 in an effort to reestablish contact. Optionally, the aquatic drone 100 may also rise to the surface to alert the user 10 of the presence of an underwater threat 30. In another embodiment the aquatic drone 100 may be placed in camera mode. When in camera mode the aquatic drone 100 operates on the surface of the water in the immediate vicinity of the user 10 if the user 10 is present on the surface of the water, such as if the user 10 is on a surfboard. Alternatively, the aquatic drone 100 operates under water in the immediate vicinity of the user 10 if the user 10 is present under the surface of the water, such as if the user 10 is snorkeling or scuba diving. When in camera mode the aquatic drone 100 points the camera 125 at the user 10. The camera 125 records video of the user 10 as the user 10 surfs or snorkels in the water. Images from the camera 125 are stored on the drone memory unit 140. The user 10 may later download the video via the USB port 165 and watch the video or share the video with others.

In another embodiment of the invention, there are a plurality of control units 200. In this embodiment, multiple users 10 may each wear a respective control unit 200. This presents a multi-user mode. In the multi-user mode the aquatic drone 100 communicates simultaneously with multiple control units 200. In this mode, when the aquatic drone 100 detects an underwater threat 30, the aquatic drone 100 sends a warning signal to the plurality of control units 200. In this way, multiple users 10 may be warned of the presence of an underwater threat 30 simultaneously.

In another embodiment of the invention, the user 10 may be located out of the water while the aquatic drone 100 is utilized. In this mode a lifeguard may place the aquatic drone 100 in the water while the user 10 remains on shore with the control unit 200. The aquatic drone 100 then prowls through a predetermined area in the water to search for the presence of an underwater threat 30. If the aquatic drone 100 detects the presence of an underwater threat 30 then the aquatic drone 100 sends a warning signal to the user 10 on the shore. The user 10 may then provide verbal warning or flag signal warning to users who are located in the water. In this mode the aquatic drone 100 would utilize the GPS unit 170 to ensure that the aquatic drone 100 remained within the predetermined area as it searched for the presence of an underwater threat 30.

1. A personal submersible aquatic drone comprising
A shaped housing
A propulsion system
One or more electromotors
A camera
A sonar unit
A wireless transponder
A battery
A microcontroller unit
A control hardware unit
Wherein said control hardware unit is configured with artificial intelligence logic to process information received from said camera, said sonar unit, and said wireless transponder.

2. The submersible aquatic drone as in claim 1 further comprising
A plurality of stabilizing fins
A GPS unit
A memory storage component
Wherein said artificial intelligence logic processes information received from said GPS unit.

3. The submersible aquatic drone as in claim 2 further comprising A USB port.

4. The submersible aquatic drone as in claim 3 further comprising
A touch screen digital display
Wherein said touch screen digital display displays information related to the operation of said submersible aquatic drone
Wherein said touch screen digital display permits a user to enter instruction information to said submersible aquatic drone.

5. The submersible aquatic drone as in claim 4 further comprising
A threat response unit
Wherein said threat response unit presents a stimulus to an underwater threat to prevent an attack on a person engaged in an aquatic activity.

6. The submersible aquatic drone as in claim 1 further comprising
A threat response unit
Wherein said threat response unit presents a stimulus to an underwater threat to prevent an attack on a person engaged in an aquatic activity.

7. The submersible aquatic drone as in claim 1 further comprising
A touch screen digital display
Wherein said touch screen digital display displays information related to the operation of said submersible aquatic drone
Wherein said touch screen digital display permits a user to enter instruction information to said submersible aquatic drone.

8. A system for exploring searching and responding to an underwater threat comprising
A submersible aquatic drone
One or more control units, said control unit comprising
A microcontroller unit
A memory storage component
A wireless transponder
Wherein said submersible aquatic drone operates within a predetermined area
Wherein said submersible aquatic drone transmits a warning signal to said control unit when said submersible aquatic drone detects the presence of an underwater threat.

9. The system as in claim 8
wherein said control unit further comprises a flexible strap housing.

10. The system as in claim 8
wherein said control unit further comprises a plurality of warning lights
Wherein said plurality of warning lights activate and enlighten when said control unit receives a warning signal from said aquatic drone.

11. The system as in claim 10
Wherein said control unit further comprises a warning sound emitter
Wherein said warning sound emitter emits an audible alarm when said control unit receives a warning signal from said aquatic drone.

12. The system as in claim 11
Wherein said control unit further comprises an alert hardware unit
Wherein said alert hardware unit vibrates or emits an electrical impulse when said control unit receives a warning signal from said aquatic drone.

13. The system as in claim 12
Wherein said control unit further comprises a plurality of control buttons
Wherein each of said control buttons provides a unique instruction to said aquatic drone.

14. The system as in claim 13
Wherein said control unit further comprises
A touch screen visual display
Wherein said touch screen visual display displays information related to the operation of said submersible aquatic drone
Wherein said touch screen visual display permits a user to enter instruction information to said submersible aquatic drone.

15. The system as in claim 14
wherein said control unit further comprises
a battery
a USB port.

16. The system as in claim 15
wherein said control unit further comprises
a flexible strap housing.

17. The system as in claim 16
Wherein said aquatic drone comprises
A shaped housing
A propulsion system
One or more electromotors
A camera
A sonar unit
A wireless transponder
A battery
A microcontroller unit
A control hardware unit
Wherein said control hardware unit is configured with artificial intelligence logic to process information received from said camera, said sonar unit, and said wireless transponder
A plurality of stabilizing fins
A GPS unit
A memory storage component
Wherein said artificial intelligence logic processes information received from said GPS unit
A USB port
A touch screen digital display
Wherein said touch screen digital display displays information related to the operation of said submersible aquatic drone
Wherein said touch screen digital display permits a user to enter instruction information to said submersible aquatic drone
A threat response unit
Wherein said threat response unit presents a stimulus to an underwater threat to prevent an attack on a person engaged in an aquatic activity.

18. The system as in claim 8
Wherein said control unit further comprises
An alert hardware unit
Wherein said alert hardware unit vibrates or emits an electrical impulse when said control unit receives a warning signal from said aquatic drone.

19. The system as in claim 8
Wherein said control unit further comprises
A plurality of control buttons
Wherein each of said control buttons provides a unique instruction to said aquatic drone.

20. The system as in claim 8
Wherein said control unit further comprises
A touch screen visual display
Wherein said touch screen visual display displays information related to the operation of said submersible aquatic drone
Wherein said touch screen visual display permits a user to enter instruction information to said submersible aquatic drone.

21. A control unit for controlling and communicating with an autonomous submersible aquatic drone comprising
a microcontroller unit
a memory storage component
a wireless transponder
a battery
wherein said control unit transmits and receives a substantially continuous signal with an autonomous submersible aquatic drone
wherein said autonomous submersible aquatic drone operates within a predetermined area.

22. The control unit as in claim 21 further comprising
a warning system
wherein said warning system alerts a user of the control unit when said autonomous submersible aquatic drone detects the presence of an underwater threat.

23. The control unit as in claim 22 further comprising
a flexible strap housing.

24. A method for surveying an aquatic environment comprising
Placing an autonomous submersible aquatic drone in the vicinity of a person engaged in a water sport
Transmitting a substantially continuous location signal from a control unit to said autonomous submersible aquatic drone
Wherein said autonomous submersible aquatic drone operates within a predetermined area.

25. The method as in claim 24 further comprising
said autonomous submersible aquatic drone following said person in the water said autonomous submersible aquatic drone pointing a camera at said person recording video of said person with said camera of said autonomous submersible aquatic drone storing said video on a memory unit located in said autonomous submersible aquatic drone.

26. The method as in claim 25 further comprising
Said autonomous submersible aquatic drone surveying the vicinity surrounding said person for the presence of an underwater threat
Transmitting a warning signal from said autonomous submersible aquatic drone to said control unit when said autonomous submersible aquatic drone detects an underwater threat
Activating an alarm in said control unit when said control unit receives said warning signal.

27. The method as in claim 26 further comprising
Responding to an underwater threat with a stimulus from said autonomous submersible aquatic drone to prevent an attack on said person wearing said control unit.

28. The method as in claim 27 further comprising
Transmitting a warning signal from said autonomous submersible aquatic drone to a plurality of control units when said autonomous submersible aquatic drone detects an underwater threat
Activating an alarm in said control unit when said plurality of control units receives said warning signal.

29. The method as in claim 26
wherein said predetermined area is established within a predetermined circumference from said control unit
wherein said person engaged in a water sport wears said control unit.

30. The method as in claim 26
wherein said predetermined area is established via a GPS signal received by said submersible aquatic drone
wherein said control unit is utilized by a person located outside of the water.
